(19) United States
(12) Patent Application Publication
(10) Pub. No.: US 2008/0272020 A1
(43) Pub. Date: Nov. 6, 2008

(54) BLISTER TRAY PACKAGE

(75) Inventor: Allen S. Aldridge, South Orange, NJ (US)

Correspondence Address: HOFFMANN & BARON, LLP, 6900 JERICHO TURNPIKE, SYOSSET, NY, 11791, US

(73) Assignee: Cadbury Adams USA LLC, Parsippany, NJ (US)

(21) Appl. No.: 12/114,253

(22) Filed: May 2, 2008

Related U.S. Application Data
(60) Provisional application No. 60/927,533, filed on May 3, 2007.

(51) Int. Cl. B65D 73/00; B32B 37/00; B31B 49/02; B23P 11/00; B29C 65/00

(52) U.S. Cl. 206/469; 206/470; 156/60; 29/428

(57) ABSTRACT

The present invention relates generally to an openable package for accommodating product. More particularly, the present invention relates to a package for accommodating product including a blister tray and a blister tray support. The package of the present invention has a blister tray with a blister cavity for accommodating a product. The package also has a blister tray cover with a back wall, a front wall overlying and enclosing a portion of the blister cavity, and an openable flap overlying the blister cavity.

### CROSS-REFERENCE TO RELATED APPLICATION

This application claims priority to U.S. Provisional Patent Application No. 60/927,533, filed on May 3, 2007, herein incorporated by reference.

### FIELD OF THE INVENTION

The present invention relates generally to an openable package for accommodating product. More particularly, the present invention relates to a package for accommodating product including a blister tray and a blister tray support.

### BACKGROUND

The art has seen a wide variety of packages for containing and dispensing products which may include confectionery products such as candy and particularly gum. One type of package includes a blister package having a blister tray and a cover which slidably receives the blister tray therein. The blister tray houses a plurality of gum pieces, each piece may be separated within the blister tray.

The art has also seen the use of a variety of other types of packages including packages having housings formed with a paperboard cover. The cover forms a front wall around the package and also provides a fold over flap which is openable to access the interior of the package. This type of package is readily reusable as the flap may be reclosed to contain the remaining products in the interior thereof. These types of packages have been widely accepted by consumers inasmuch as they provide a convenient openable package which allows dispensing of less than all the contents and yet allows reclosing of the package to contain the remaining contents.

One benefit of these paper board packages is that the package is unified, i.e., it is essentially one piece. This facilitates use of handling of the product, whereas conventional blister tray packages include an outer package and a blister tray designed for separation from the package which must be separately handled by the user.

It is desirable, therefore, to provide a package which has the beneficial attributes of both a blister package as well as a paperboard package.

### SUMMARY

A package is provided including a blister tray and a cover. The blister tray has an upwardly opening blister cavity. A blister tray cover is positioned to overlie the open blister cavity. The cover is displaceably attached to the blister tray to expose the cavity for dispensing of the product contained therein.

A further package is provided for containing product. The package includes a blister tray having an upwardly opening blister cavity for accommodating the product. A blister tray cover surrounds the blister tray. The cover includes a back wall and a front wall overlying a portion of the blister cavity. The cover also includes an openable flap overlying the blister cavity and the front wall for enclosing the blister cavity. The front wall may include a slot and the flap may include a tab for insertion into the slot so as to reclose the cover.

Additionally, the blister cavity may be covered by a moisture barrier. The moisture barrier maybe in the form of a liner overlying the cavity and may be provided with a score line thereacross which separates the liner. A portion of the liner maybe secured to the flap so that upon opening the flap a portion of the liner is removed from the blister tray to allow access to the product.

Further, the blister tray cover may include a wall overlying the blister tray. The cover may have an opening therethrough to access the products in the blister cavity. The opening in the cover may include thereover a structure of a liner to permit dispensing of the product therethrough.

A process for manufacturing a package is provided including a blister tray and a cover. The blister tray package has an intermediate portion forming a back wall, a lower portion forming a front wall overlying a portion of a blister cavity, and an upper flap portion overlying said blister tray slot and with said lower portion of said cover enclosing said blister tray slot. First, an adhesive is dispensed along the intermediate portion of the cover. Next, the package is folded into the closed position creating a blister tray slot, with the upper flap overlying at least a portion of the blister tray slot and a portion of the lower portion of the cover. An adhesive is then dispensed on a scored portion of the lower portion of the cover. Lastly, the blister tray is slid into the cover and secured to the intermediate portion of the cover.

### BRIEF DESCRIPTION OF THE DRAWINGS

FIG. 1 is a front plan view of one embodiment of a blister tray package of the present invention.

FIG. 2 is a rear view of the partially assembled blister tray package of FIG. 1.

FIG. 3 shows the blister tray package of FIG. 1 in the closed condition.

FIG. 4 shows the blister tray package of FIG. 1 in the open position.

FIG. 5 shows a flat blank used to form a cover of a further embodiment of the blister tray package of the present invention.

FIG. 6 shows the cover of FIG. 5 with a blister tray attached thereto.

FIG. 7 shows the blister tray package of FIG. 6 in the open condition.

FIG. 8 shows the blister tray package of FIG. 6 in a partially closed condition.

FIGS. 9 and 10 show a still further embodiment of blister tray package of the present invention in both the open and closed conditions respectively.

FIG. 11 shows the blister tray employed with the package of FIGS. 9 and 10.

FIGS. 12 and 13 show blister tray FIG. 11 with a barrier disposed thereover.

FIG. 14 shows the paper board cover applied with over the blister tray of FIG. 13.

FIGS. 15 and 16 show the blister tray of FIG. 13 supported within the paper board cover of FIG. 14.

FIG. 17 is a perspective showing of a further embodiment of a blister tray package in accordance with the present invention.

FIG. 18 shows the blister tray package of FIG. 17 in the opened condition.

FIG. 19 shows an opposite surface of the blister tray package of FIG. 18 shown in the opened condition.

FIG. 20 shows a still further embodiment of the blister tray package of the present invention in closed condition.

FIG. 21 shows the blister tray package of FIG. 20 in the opened condition.

FIG. 22 shows the blister tray package of FIG. 21 with the blister trays flipped out from the package.

FIG. 23 shows a still further embodiment of the blister tray package of the present invention with the blister tray in the open position.

FIG. 24 shows the blister tray package of FIG. 23 with the front wall closed and the adhesive spots visible on the lower portion and upper flap portion.

FIG. 25 shows the lower portion of the cover with adhesive on top of the scored area.

### DETAILED DESCRIPTION OF THE PREFERRED EMBODIMENT

The present invention provides a blister tray package including a blister tray and blister tray cover where the blister tray is attached to the blister cover and yet is accessible to remove product from the blister tray while maintaining the blister tray in attachment to the blister tray cover.

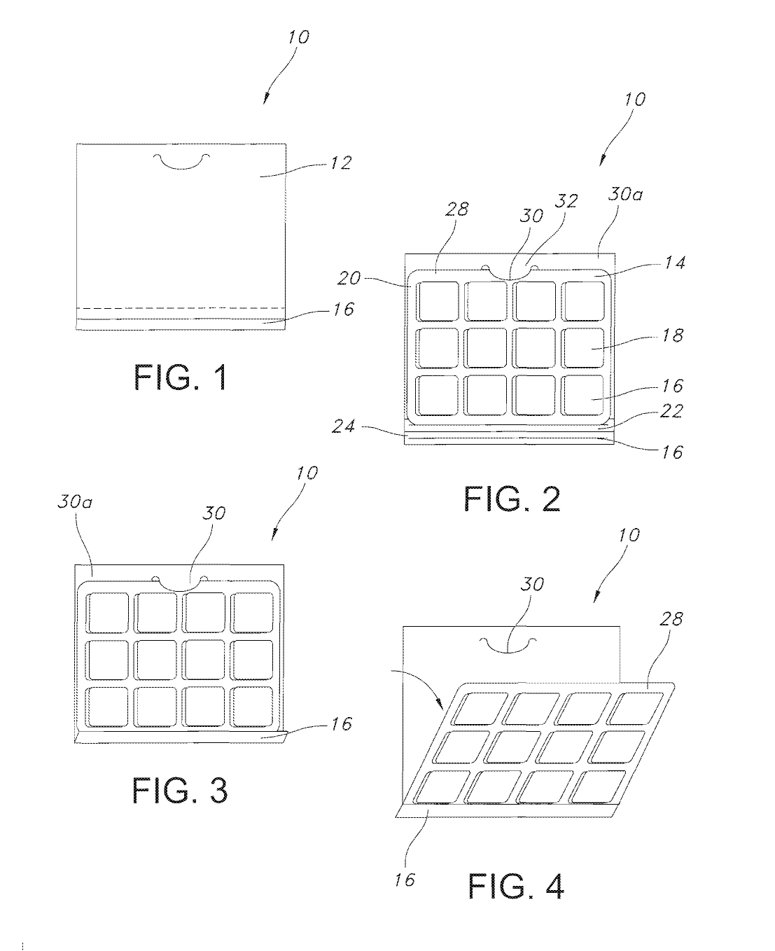

Referring to FIGS. 1-4, a first embodiment of the present invention is shown. The blister tray package assembly 10 includes a cover 12 shown in FIG. 1 and a blister tray 14. The cover 12 may be a conventional paperboard cover which may also include a multi-laminate design. The cover is generally rectangular in configuration so as to match the configuration of blister tray 14. However, it may be appreciated that other configurations may be employed in combination with the present invention. The cover 12 includes a lower foldable edge 16 which is shown in FIG. 2 and may be folded up and over an edge of the blister tray. The blister tray 14 is of generally conventional construction and may be formed of a suitable plastic material. The blister tray includes a plurality of blister cavities or depressions 16 which support individually therein a product 18 such as a confectionery product more particularly gum pieces. While gum pieces of a particular shape are shown, the present invention may support product having various configurations such as slabs, sticks, pellets, pillows and the like. Also, the present invention is not limited to gum pieces and may support a wide variety of confectionery products such as gum, candy, chocolate, as well as non-confectionery products.

In addition, while one particular configuration of the blister tray and blister depressions is shown, other sizes and configurations, including more or less blister tray depressions may also be provided. In addition, the blister depressions may hold more than one gum piece.

The blister tray 14 includes a perimeterical edge 20 therearound. A lower edge 22 is designed for being positioned within the folded up end 16 of cover 10. Edge 22 may be secured to end 16 of cover 10 by a strip of glue 24 or other adhesive so that when the edge 16 is folded up over edge 22 as shown in FIG. 3, the edge 22 will be adhesively secured to the cover thereat. While adhesive securement is shown, other securement techniques may also be employed.

The upper edge 28 of blister tray may be releaseably supported by a tab 30 formed on the upper portion 30a of blister cover 12. The tab 30 is cut from the flat blank material forming the blister cover 12 and includes a depending portion 32 which rides over edge 28 of blister tray 14 to provide removable securement of the blister tray therein. Thus, the blister tray as shown in FIG. 3 is secured between the adhesive securement location at edge 16 along one edge thereof and at the opposite edge to tab 30. While the tab is shown centrally located on the upper portion 30a, it may be located anywhere therealong or on other edges of cover 12. Moreover, plural tabs may be employed at various locations about the edges of cover 12. In addition, other shapes and configurations of tabs may be employed.

As shown in FIG. 4, the folded edge 16 forms a hinge so that when tab 30 is released from edge 28, the blister tray will pivot at edge 16 so that the blister tray maybe moved away from cover 12. While the hinge formed by edge 16 is shown extending fully across the tray 14, in some embodiments it may extend lass than the entire length across. The cavities 18 of blister tray 14 have open surfaces which are typically covered by a moisture barrier such as a liner formed of rupturable foil or other laminate or combinations thereof. The laminate may be formed of a wide variety of materials, such as polypropylene, polyethylene, as well as oriented polypropylene and polyethylene and combinations thereof. The liner may serve various functions, such as a moisture barrier, environmental protection, tamper indicator, as well as other functions and combinations thereof. Access to the open ends of the blister cavities allows dispensing of one or more of the gum pieces from the individual cavities 18. Once one or more gum pieces are dispensed, the blister tray may be pivoted back into contact against cover 12 and the edge 28 is secured to the tab 30 maintaining the blister tray in closed condition with respect to cover 12.

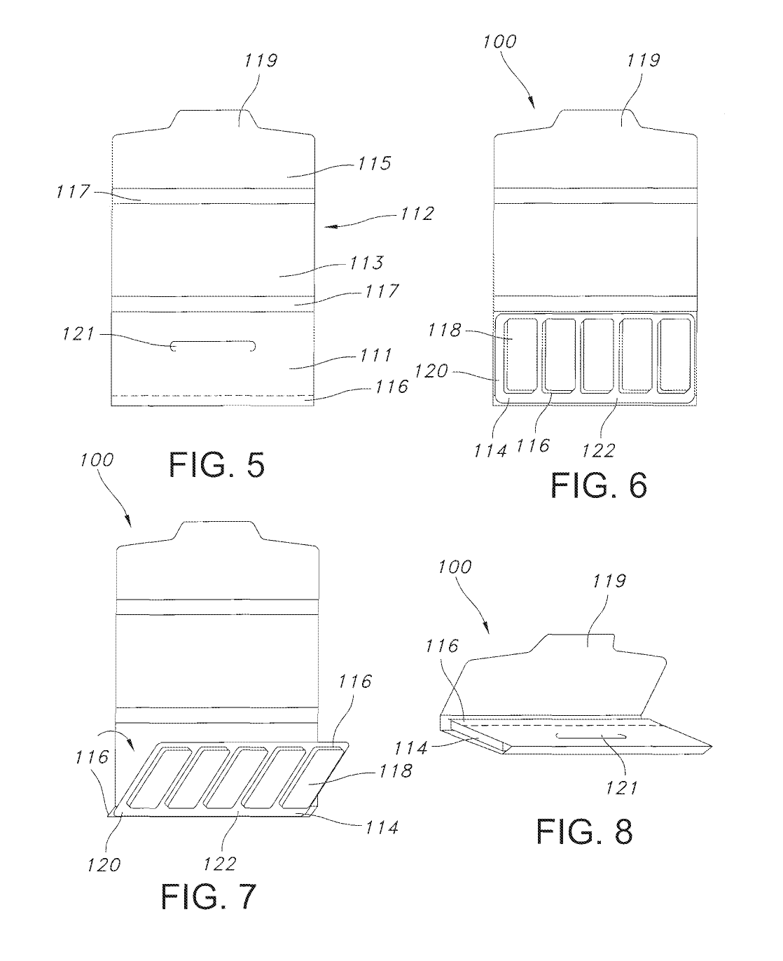

A further embodiment of the present invention is shown with respect to FIGS. 5-8. This embodiment of the blister tray package assembly 110 includes a blister cover 112 shown in FIG. 6 and blister tray 114. The cover 112 may also be a conventional paper board cover which may also include a multi-laminated design. The cover 112 includes a lower portion 111, an intermediate portion 113 and an upper flap portion 115. Each portion is separated by foldable locations 117.

The blister tray 114 is of conventional construction and may be formed from a suitable plastic material. The blister tray 114 includes a plurality of spaced apart blister depressions 116 which support individual product 118 such as a confectionary product, more particularly gum pieces.

Blister tray 114 includes a perimetrical edge 120 therearound. A lower edge 122 of perimetrical edge 120 is secured to an end extent 116 extending from a lower portion 111. The edge 122 may be secured to end extent 116 of cover 112 by glue or other suitable adhesive. Other securement techniques may also be employed. The tray 114 is secured so that the open end of the blister depressions face the lower portion 111 of cover 112. The open front face of the blister depressions 116 may also be sealaby covered by a barrier such as a liner formed of rupturable foil or other laminate liner or combinations thereof. The liner may serve various functions, such as a moisture barrier, environmental protection, tamper indicator, as well as other functions and combinations thereof.

As shown in FIG. 6, blister tray 114 is positioned in the closed condition against lower portion 111 of cover 112. As shown in FIG. 8, the blister tray may be closed by cover 112 by folding the lower end 111 including the blister tray 114 against central location 113. The flap 115 may then be folded over to close the package. The flap 115 includes a centrally located tab 119 which is insertable into an associated slot 121 in lower portion 111 which maintains the tray 114 in a closed condition. While the tab 119 and slot 121 are shown centrally located, they may be also located asymmetrically positioned on the package. Moreover, the tabs 119 and slot 121 may have other shapes and configurations and may be located at other positions. Additionally, more than one tab and slot may be employed.

In order to employ the package to dispense gum products, the flap 115 is opened by removing the tab 119 from slot 121 and the blister tray 114 is folded away from the central location 113. Blister tray 114 is then pivotally opened away from lower portion 111 being secured thereto only along lower edge 122. One or more gum pieces 118 may be dispensed therefrom and the package may then be re-closed by folding over cover 112 and placing the tab 119 in slot 121.

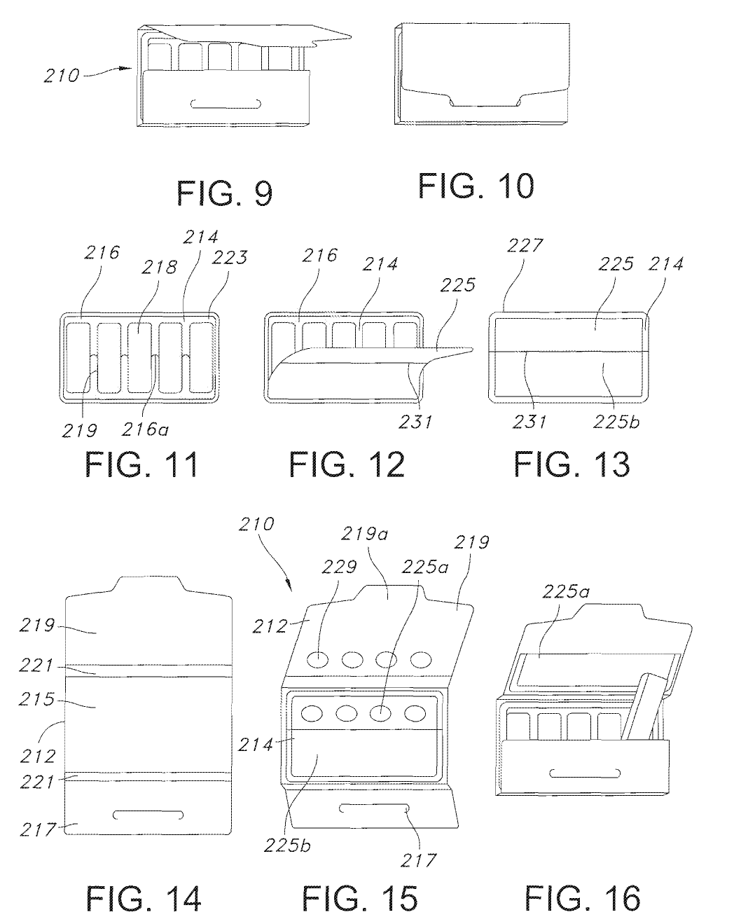

Turning now to FIGS. 9-16, a still further embodiment of the present invention is shown. FIGS. 9 and 10 show a package configuration similar to that disclosed in FIGS. 5-8.

Package assembly 210 includes a blister cover 212 shown in FIG. 14 and a blister tray 214 shown in FIGS. 11-13. The cover 212 is a conventional paperboard cover which may also include a multi-laminate design. The cover includes a central portion forming a back wall 215, a lower portion forming a front wall 217 and an upper flap 219. Each of these portions is separated by foldable locations 221.

The blister tray 214 is generally of conventional construction and may be formed of a suitable plastic. The blister tray includes blister depressions 216 having an open face 223. The blister depression 216 is sectioned by a plurality of partially extending spaced apart walls 218. The walls 218 separate the blister depression 216 into blister cavities 216a which contain and support individually a plurality of products 218 such as confectionary product, more particularly, gum pieces.

The open front face 223 of blister tray 214 may have disposed thereover a liner 225. Liner 225 is typically a foil cover or in the alternative may be formed by a multi-laminate construction or combinations thereof. The liner may serve various functions, such as a moisture barrier, environmental protection, tamper indicator, as well as other functions and combinations thereof. Liner 225 is designed to completely enclose the open front face 223 of blister tray 214 and may be secured to the blister tray along its perimetrical edge 227 by adhesive or other securement techniques. The liner 225 may be scored transversely thereacross at a score line 231 so as to permit separation therebetween. The score line 231 may be a perforation, a laser cut or any other score line which divides the liner into an upper portion 225a and a lower portion 225b. The score line 231 extends partially through the liner so as to maintain the liner integrity providing an environmental seal for the products 218 supported within the blister tray 224.

Turning now to FIG. 15, the blister tray 214 including the liner 225 thereover may be supported within the paperboard cover 212. The blister tray 214 is positioned against central location 215 with the open front face 223 facing outwardly. The blister tray 214 may be supported against the central portion of paperboard cover 212 by adhesive or other securement technique.

The blister tray 214 is then enclosed within the paperboard cover by folding up the front wall 217 and folding down the upper flap 219 and securing a tab 219a of upper wall 219 within a slot 217a of front wall 217. In addition to enclosing the blister tray 214 therein, the upper flap 219 becomes adhesively secured to the upper portion 225a of foil liner 225. As shown in FIG. 15, the flap 219 and/or the upper portion 225a of foil liner 225 may include one or more adhesive locations 229 thereon which adhesively secure the flap to the upper portion 225a of cover 225. The adhesive locations 229 are shown by way of example. Other techniques to secure the flap 219 to the upper portion 225a of cover 225 may be employed.

Turning now to FIG. 16, use of the package to dispense one or more products 218 is shown. The flap 219 is opened by releasing tab 219a from the slot 217a in front wall 217. Upon pivotally opening the flap, the adhesive securement of the flap to the upper portion of liner 225a effects detachment of the upper portion 225a of liner 225 from the lower portion 225b along score line 231. The upper portion 225a being adhesively secured to the flap, tears along a score line 231 so as to expose the upper end of the blister tray 214 to permit removal of one or more products 218 therefrom. Once the products are removed, as shown in FIG. 9, the flap 219 may be closed and the tab reinserted into slot 217a as shown in FIG. 10 to reclose the package assembly.

The relationship between liner 225 and flap 219 allows the liner to completely close and seal the blister depressions prior to initial use. This provides protection to the products 218 held therein. The adhesive securement of flap 219 to upper portion 225a allows opening of the liner for access, but also allows reclosing when the flap 219 is closed.

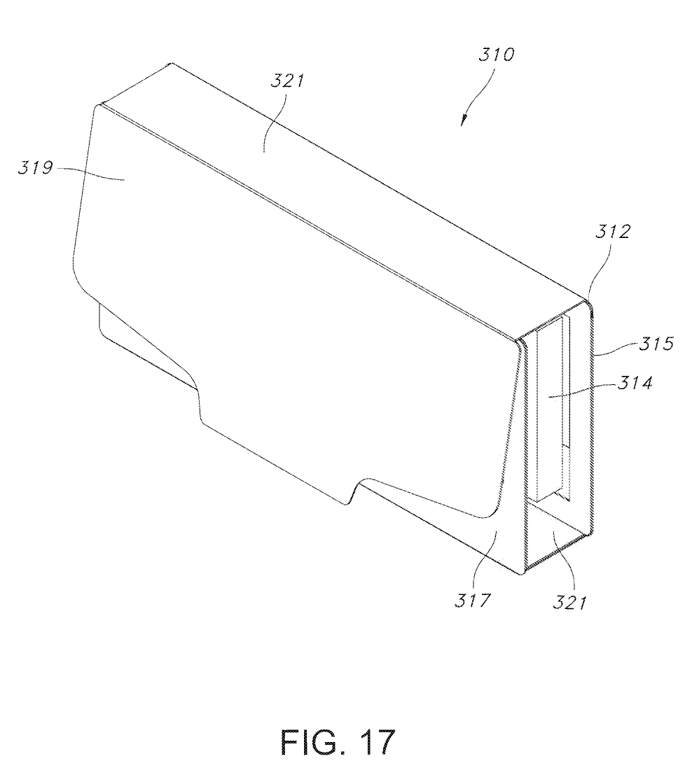

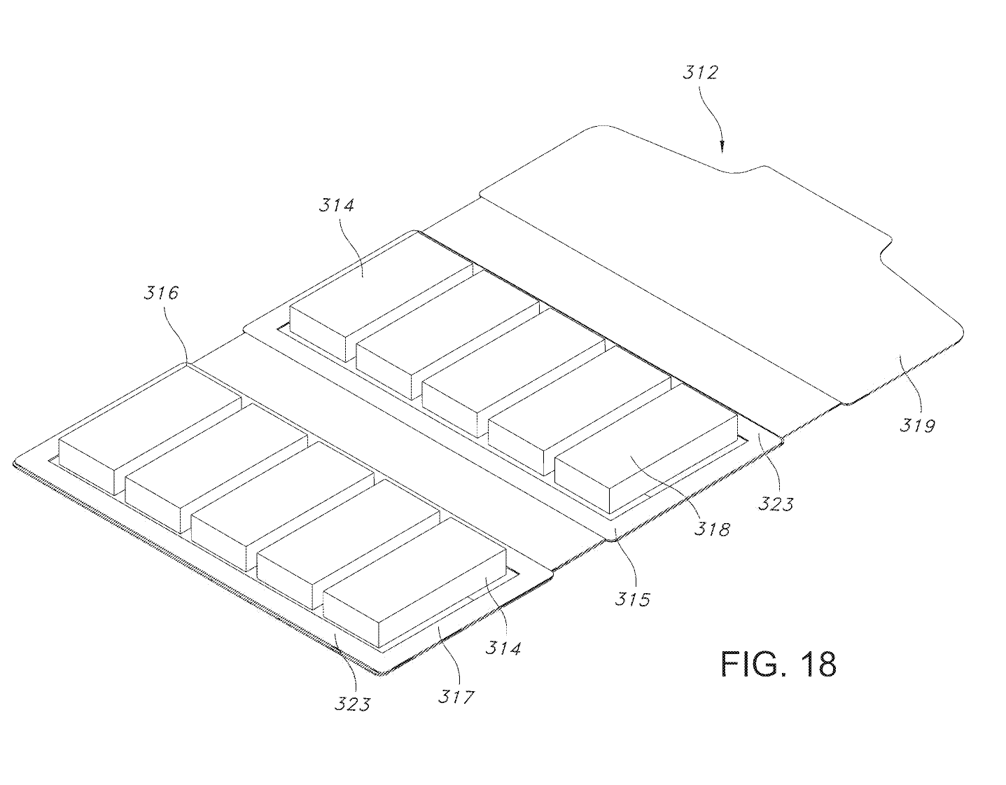

Referring now to FIGS. 17-19, a further embodiment of the present invention is shown. Package assembly 310 includes a blister cover 312 and a pair of blister trays 314 shown in FIG. 18. As with the above embodiments, the cover 312 is a conventional paperboard cover which may also include a multi-laminate design. The cover includes a central portion forming a back wall 315, a lower portion 317 forming a front wall and an upper portion forming a flap 319. Each of these portions is separated by foldable locations 321.

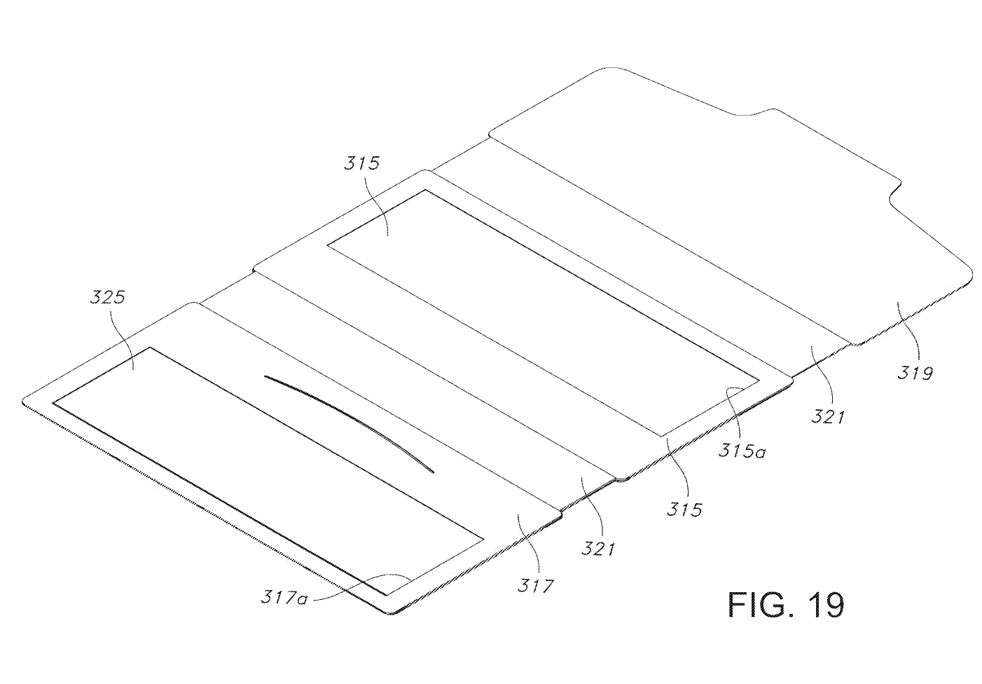

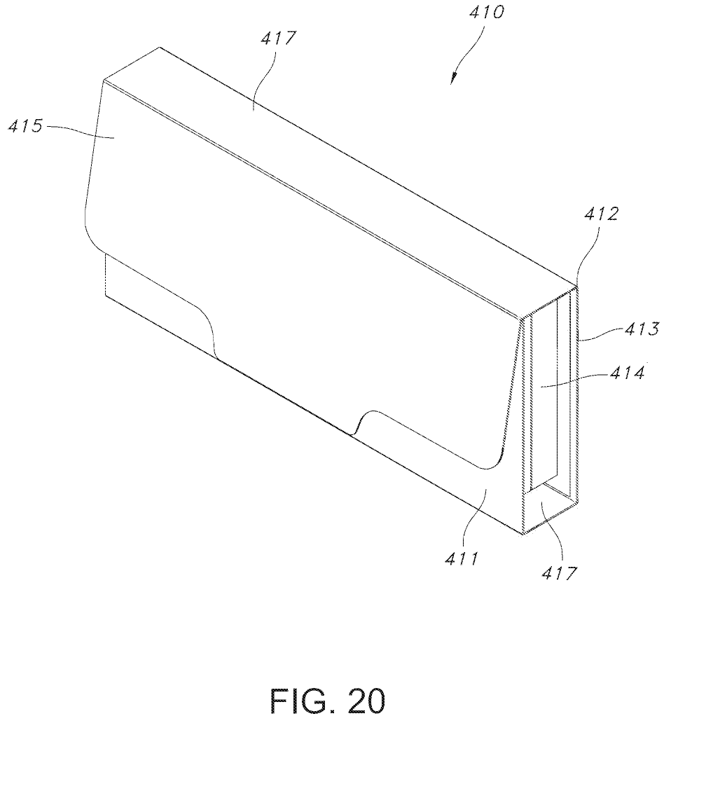

As shown partially in FIG. 19, each of back wall 315 and front wall 317 includes an open window 315a and 317a which is generally rectangular in shape. However, other shapes and configurations may also be employed. The open windows are covered by a liner 325 which is adhered thereover covering the window. The liner 325 may be a typical foil cover, or in the alternative, may be formed by a multi-laminate construction or combinations thereof. The liner is suitable for serving various functions, such as moisture protection, environmental protection, tamper indication, as well as other functions and combinations thereof. Each of the blister trays 314 are generally of conventional construction and may be formed of a suitable plastic. The blister trays includes a plurality of blister depressions 316 having open faces 323. The blister depressions 316 are sectioned by a plurality of extending walls 318. The walls separate the blister depression 316 into blister cavities 316a which contain and support individually a plurality of products 318 such as confectionery products, more particularly gum pieces. The open faces of the blister trays 314 may be positioned against the cover are shown in FIG. 18. The blister trays include a perimetrical rim 323 therearound which may be adhesively secured to the cover about the windows 315a and 317a. In this position, the liners 325 enclose the open front face of the blister trays. The products contained therein are thereby provided with environmental protection. The liners 325 are rupturable so as to permit dispensing of one or more of the products 318 therethrough.

The package assembly 310 of the present embodiment is used in the following manner. The package assembly is folded in a configuration shown in FIG. 17 with the front wall 317 being folded up at location 321 onto back wall 315. The front flap 319 is adhesively secured to front wall 317 closing the package assembly 310.

To use the package assembly 310, the front flap 319 is lifted by use of the extending tab 319a. The adhesive seal is broken and the cover may be opened into the configuration shown in FIG. 18. One or more gum pieces may be dispensed from the blister trays through the rupturable liner 325 with the remaining pieces being environmentally protected by the liner. The package assembly 10 may be reclosed by folding the front wall 317 up towards back wall 315 and then folding flap 319 down over front wall 317. The tab 319a of flap 319 may be inserted in slot 317a to reclose the package assembly 310. Other configurations and locations of the tab and slot are also contemplated.

A still further embodiment of the present invention is shown in FIGS. 20-22. The embodiment of FIGS. 20-22 is substantially similar to the embodiment shown above with respect to FIGS. 5-8.

The present embodiment includes a package assembly 410 which includes a blister cover 412 and a pair of blister trays 414. The cover 412 may also be conventional paperboard cover which may include a multi-laminate design. The cover 412 includes a lower portion 411 forming a front wall, an intermediate portion 413 forming a back and an upper flap portion 415. Each portion is separated by foldable locations 417.

The blister trays 414 are of conventional construction and may be formed from a suitable plastic material. The blister trays include a plurality of spaced apart blister depressions 416 which individually support a product 418 such as a confectionery product more particularly gum pieces. Each blister tray 414 includes a perimetrical edge 420 therearound. Each blister tray 414 includes one edge 422 for securing the blister tray to the cover 412.

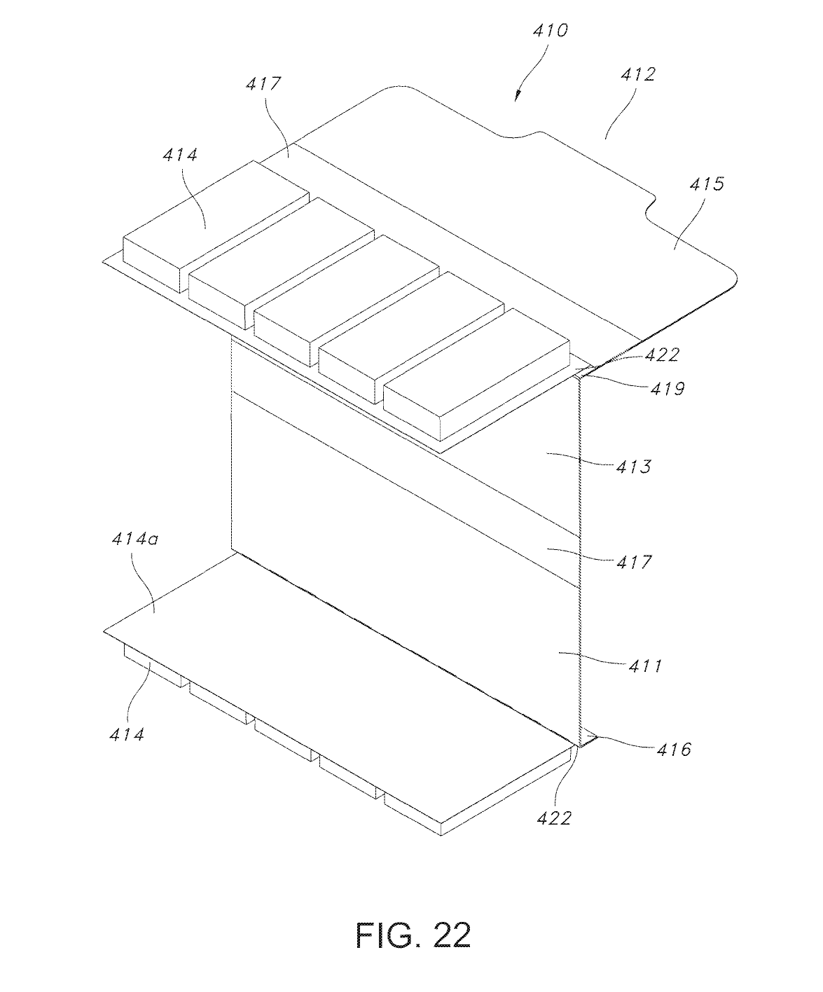

As shown in FIG. 22, the edge 422 of one blister tray is secured to a distal edge 416 of lower portion 411 while an edge 422 of the other blister tray is secured to an upper edge 419 of intermediate portion 413. The edges 422 may be secured by glue or other suitable adhesives. Also other securement techniques may be employed. Blister trays 414 are secured so that the open faces of the blister depression face cover 412. The open front faces of the blister depressions may also be sealably covered by a barrier such as a liner 414a formed of rupturable foil or other laminate materials or combinations thereof. The liner serves various functions such as a moisture barrier, environmental protection, tamper indicator, as well as combinations thereof.

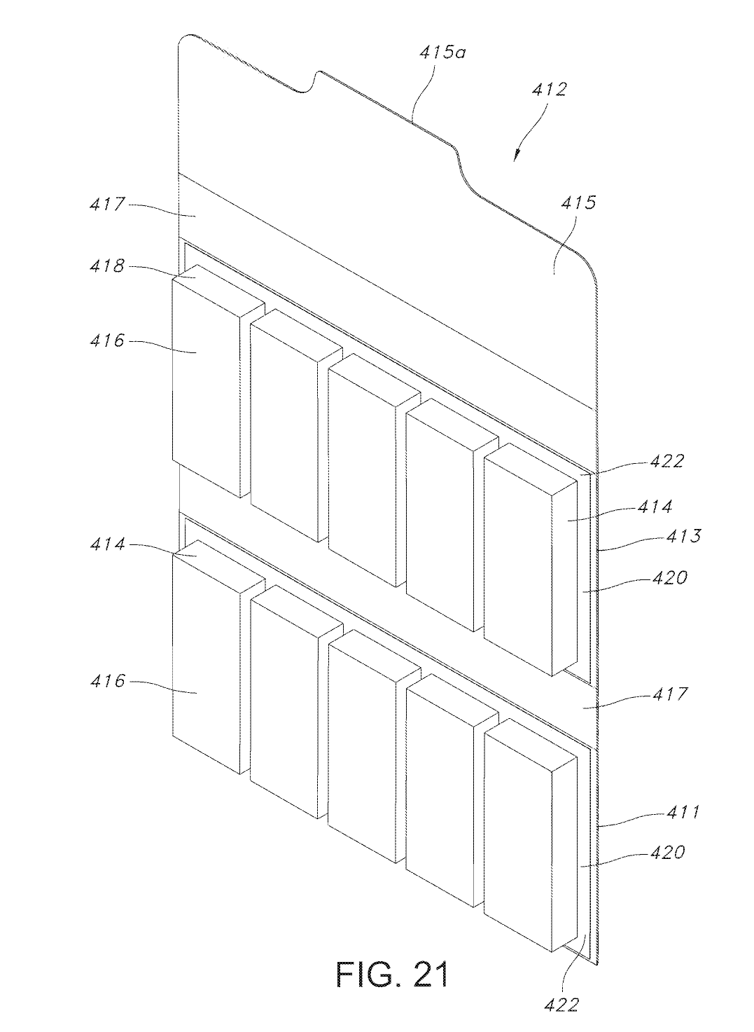

As shown in FIG. 21, the blister trays 414 are positioned in a closed condition against cover 412. The package assembly may be closed by folding the lower end 411, including blister tray 414 against the central location 413. This places the two blister trays in facing opposition. The flap 415 may then be folded over the closed package. The flap may be adhesively secured by a releaseable adhesive.

In order to employ the package of the present invention, flap 415 is opened and the lower portion 411 is folded out from the intermediate portion 413. Either or both of the blister trays 414 may be pivotally opened away from cover 412 to expose the faces of the blister trays covered by the liner. One or more gum pieces may be dispensed from the blister trays by forcing the gum pieces through the liner. The blister trays may be folded down against the cover after the pieces are dispensed and then the package may be reclosed by folding the lower portion 411 up towards intermediate 413. Thereafter, the flap 415 may be folded over and tab 415a of flap 419 may be inserted into a slot in the front wall. Other configurations and locations of the flap and tab are also contemplated.

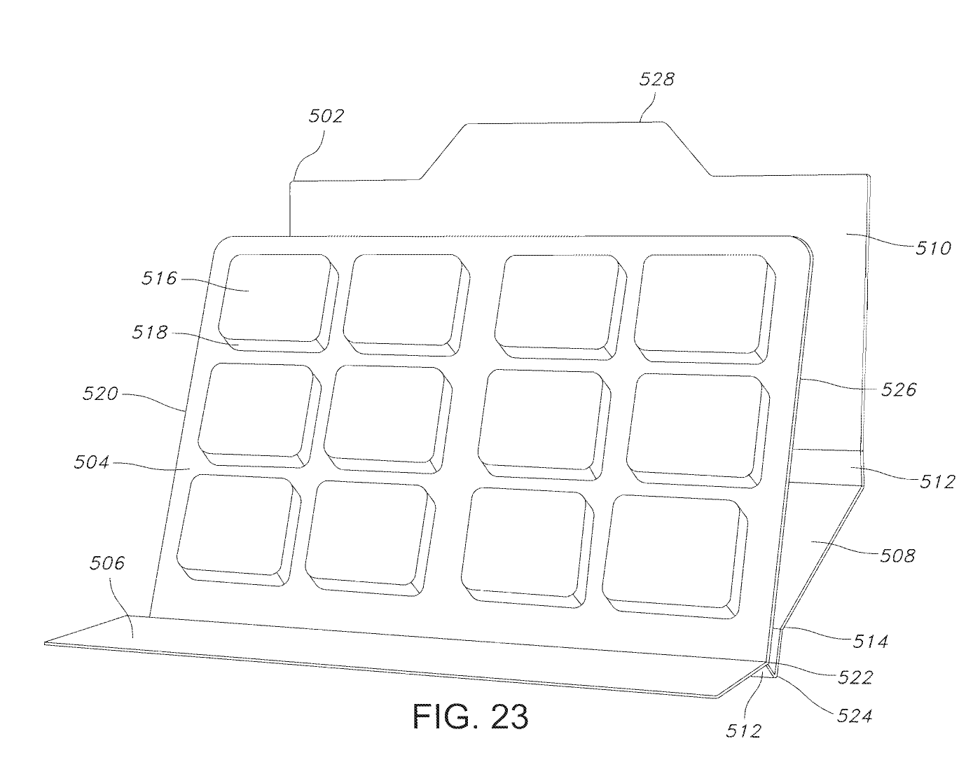

FIG. 23 contains an additional embodiment of a package assembly 500 which includes a blister tray cover 502 and a blister tray 504. The cover 502 may be a conventional paperboard cover which may include a multi-laminate design. The cover 502 includes a lower portion 506 forming a front wall, an intermediate portion 508 forming a back wall, and an upper flap portion 510. Each of theses portions are separated by foldable locations 512. Above the foldable location between the intermediate portion 508 and the lower portion 506 is a perforated line 514. The perforated line 514 provides a more flexible a hinge, making it easier to access the blister tray.

The blister trays 504 are of conventional construction and may be formed from a suitable plastic material. The blister trays include a plurality of spaced apart blister depressions 516 which individually support a product 518 such as a confectionary product, more particularly gum pieces. Each blister tray 504 includes a perimetrical edge 520 therearound. Each blister tray 504 includes an elongate edge 522 for securing the blister tray to the corner 502. The blister tray 504 of the present invention may be a single blister tray or a double blister tray with a perforation between the trays.

As shown in FIG. 23, the elongate edge 522 of one blister tray is secured to a distal edge 524 of intermediate portion 508. The elongate edge 522 may be secured by glue, wax, or other suitable adhesive. Also other securement techniques may be employed. The blister tray 504 is secured so that the open faces of the blister depressions 516 face the intermediate portion 508. The open front faces of the blister depressions may also be sealably covered by a barrier such as a blister tray liner 526 formed of rupturable foil or other laminate materials or combinations thereof. The liner serves various functions such as a moisture barrier, environmental protection, tamper indicator, as well as combinations thereof.

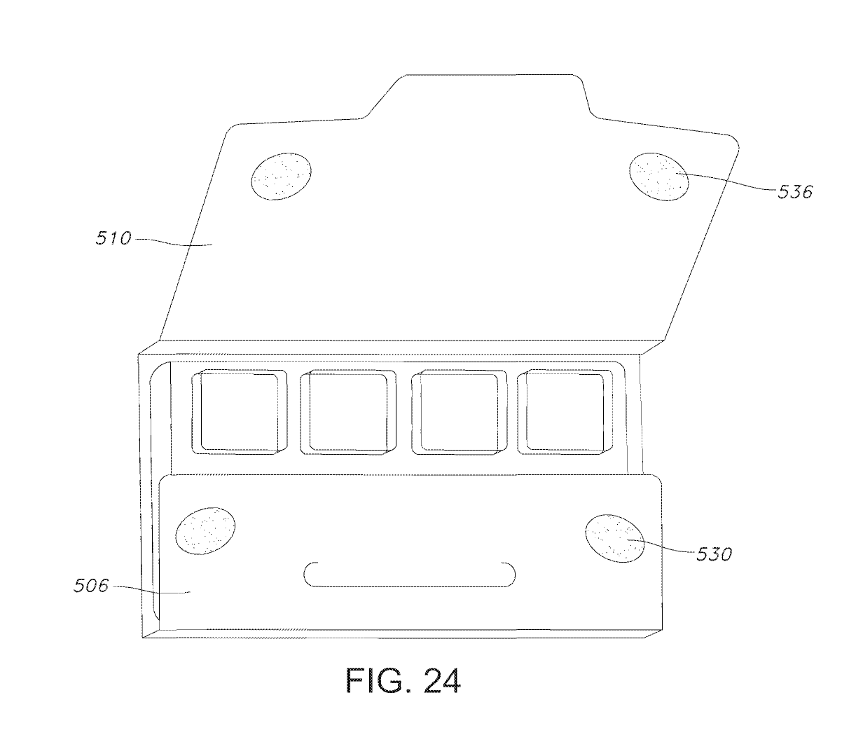

The package is manufactured by dispensing an adhesive to the distal edge 524 of the intermediate portion 508. Then, the lower portion 506 is folded upward towards the intermediate portion 508 and the upper flap portion 510 is folded downward over the lower portion 506 to close the cover. One or more adhesive spots 530 are provided on the front wall so as to attach the upper flap portion 510 to the lower portion 506, as shown in FIG. 24. While the package is in a closed position, a blister tray slot is created, allowing the blister tray 504 to be inserted into the blister tray slot with the blister tray liner 526 facing the intermediate portion 508 of the cover. The adhesive attaching the elongate edge 522 of blister tray 504 to the distal edge 524 of the intermediate portion 508 is activated by heat after the blister tray 504 is inserted into the package. This secures the elongate edge 522 to the distal edge 524 of the intermediate portion 508.

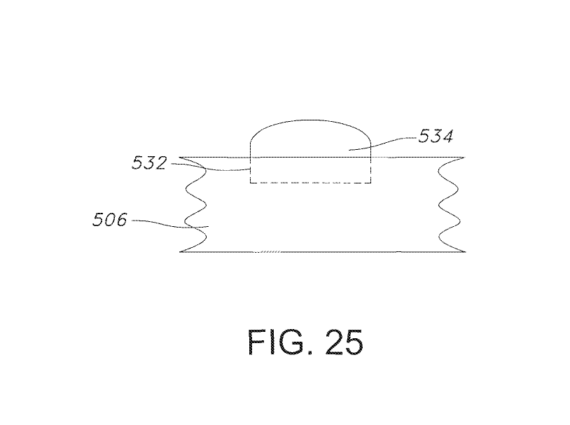

The adhesive employed herein may be glue, wax, or other suitable adhesive. FIG. 25 shows the forming the adhesive spots 530, with the lower portion 506 scored below the surface thereto 532. The scoring is accomplished by perforating the lower portion 506 of the cover approximately one-half the depth of the adhesive 532. This allows accommodation of the adhesive 534. Scoring the package 532 at the adhesive spots 530 prior to adding the adhesive enables a scored portion on the lower portion 506 of the cover and the adhesive to release from the lower portion 506, when the cover is opened, as shown in FIG. 24. Therefore, when the package is in the open position, both the adhesive 534 and the scored portion 532 remain attached 536 to the upper flap portion 510.

In order to employ the package of the present embodiment, the upper flap portion 510 is opened and the lower portion 506 is folded out from the intermediate portion 508. The blister tray 504 may be pivotally opened away from the intermediate portion 508 to expose the faces of the blister trays covered by the liner 526. Note that having the perforated line 514 makes it easier to pivot the blister tray 504 away from the intermediate portion 508 and access the gum pieces. One or more gum pieces may be dispensed from the blister trays 504 by forcing the gum pieces through the liner 526. The blister trays 504 may be folded down against the cover after the pieces are dispensed and then the package may be reclosed by folding the lower portion 506 up towards the intermediate portion 508. Thereafter the upper flap portion 510 may be folded over and tab 524 of upper flap portion 510 may be inserted into a slot in the front wall of the lower portion 506. Other configurations and locations of the upper flap portion 510 and tab 528 are also contemplated.

While the invention has been described in related to the preferred embodiments with several examples, it will be understood by those skilled in the art that various changes may be made without deviating from the fundamental nature and scope of the invention as defined in the appended claims.

What is claimed is:

1. A package comprising:
a blister tray having a blister cavity for accommodating product; and
a blister tray cover having a back wall, a front wall overlying a portion of said blister cavity and an openable flap overlying said blister cavity and with said front wall enclosing said blister cavity.

2. A package of claim 1 wherein said front wall includes a slot and wherein said flap includes a tab for insertion into said slot for receiving said flap.

3. A package of claim 1 wherein said blister cavity includes individual compartments each for accommodating one of said products.

4. A package of claim 1 wherein said blister tray includes a barrier thereon overlying of said blister cavity.

5. A package of claim 4 wherein said barrier includes a liner, and wherein said liner includes a score line thereacross to define a lower portion adjacent said front wall and an upper portion adjacent said flap.

6. A package of claim 5 wherein said liner is film formed from the group consisting of plastic and metal foil and combinations thereof.

7. A package of claim 5 wherein said upper portion of said liner is secured to said flap.

8. A package of claim 5 wherein said upper portion of said liner is removable from said lower portion upon said opening of said flap.

9. A package of claim 5 wherein said score line extends partially through said liner.

10. A package of claim 9 wherein said score line includes a perforation.

11. A package comprising:
a blister tray having a blister cavity for accommodating product;
a blister tray cover overlying said blister cavity;
said blister tray cover being displaceabily attached to said blister tray to expose said cavity for removal of said product.

12. A package of claim 11 wherein said blister tray includes an elongate edge and wherein said blister tray cover is attached to said edge and displaceable thereabout.

13. A package of claim 12 wherein said blister cover includes an opposed elongate edge, said elongate edge includes a slot for retentive engagement of an adjacent edge of said blister tray.

14. A package of claim 11 wherein said blister cover includes a lower portion, an intermediate portion and a flap portion each portion separated by a foldable portion.

15. A package of claim 14 wherein said blister tray is displaceabily attached to said lower portion of said cover.

16. A package of claim 15 wherein said lower portion of said cover and said blister tray is foldable into contact with said intermediate portion.

17. A package of claim 16 wherein said flap is foldable over said intermediate portion to close said package.

18. A package of claim 16 wherein said lower portion includes a slot and said flap portion includes a tab for removable insertion in said slot.

19. A package of claim 11 wherein said blister tray includes a barrier thereon overlying said blister cavity.

20. A package of claim 14 wherein said lower portion supports a first said blister tray and where said intermediate portion supports a second said blister tray.

21. A package of claim 20 wherein each of said lower portion and said intermediate portion includes an elongate edge for attachment of said first and second blister trays respectively.

22. A package of claim 21 wherein said first and second blister trays are displaceable about said elongate edges.

23. A package comprising:
a blister tray having a blister cavity for accommodating product;
a blister tray cover having a wall overlying said cavity and an openable flap, said cover including an access opening therethrough for accessing said blister cavity and a rupterable liner over said opening for overlying said blister cavity and permitting dispensing of said product therethrough.

24. A package of claim 23 wherein said blister tray cover includes a lower portion, an intermediate portion and a foldable portion therebetween.

25. A package of claim 24 wherein said lower portion includes a first said opening, a first said inner liner thereover and a first said blister tray secured thereto and wherein said intermediate portion includes a second said opening, a second said liner thereover and a second said blister tray secured thereto.

26. A package assembly comprising:
a blister tray having a blister cavity for accommodating a product;
a blister tray package for enclosing said blister tray; and
said blister tray being adhesively secured to said package at a hinge to permit pivotal movement of said blister tray with regard to said package to thereby exposes said blister cavity for removal of said product therefrom.

27. A package assembly of claim 26 wherein said blister tray package includes a lower portion, an intermediate portion and an upper flap portion each portion separated by a foldable portion.

28. A package assembly of claim 27 wherein said blister tray is hingably attached to a distal edge of said intermediate portion of said cover.

29. A package assembly of claim 28 wherein said intermediate portion of said cover contains a perforated line above the distal edge where said blister tray is attached.

30. A package assembly of claim 29 wherein said lower portion of said cover and said blister tray is foldable into contact with said intermediate portion of said cover.

31. A package assembly of claim 30 wherein said upper flap portion of said cover is foldable over said intermediate portion to close said package.

32. A package assembly of claim 30 wherein said lower portion of said cover includes a slot and said upper flap portion of said cover includes a tab for removable insertion in said slot.

33. A package assembly of claim 26 wherein said blister tray is a single blister tray.

34. A package assembly of claim 26 wherein said blister tray is a double blister tray with a perforated line separating each blister tray.

35. A package assembly of claim 27 wherein said lower portion of said cover is attached to said upper flap portion of said cover with an adhesive positioned on the lower portion of said cover.

36. A package assembly of claim 35 wherein said lower portion of said cover is scored under said adhesive.

37. A package assembly of claim 36 wherein a scored portion of said cover is detachable from said lower portion of said cover.

38. A package assembly of claim 37 wherein said lower portion of said cover is scored one-half the depth of the thickness of the adhesive.

39. A package assembly of claim 38 wherein when said package is closed, a portion of said upper flap portion of said cover is in contact with said adhesive.

40. A package assembly of claim 39 wherein when said package is opened, said adhesive remains in contact with said upper portion of said cover; and said scored portion of said cover is detached from said lower portion of said cover.

41. A process for manufacturing a package assembly comprising:
providing a blister tray cover having an intermediate portion forming a back wall, a lower portion forming a front wall overlying a portion of a blister cavity, and an upper flap portion overlying said blister tray slot and with said lower portion of said cover enclosing said blister tray slot;
closing said package wherein said lower portion of said cover encloses said blister tray slot and said upper flap portion overlies at least a portion of said blister tray slot and at least a portion of said lower portion of said cover; and
sliding said blister tray into said cover, such that said blister tray is secured to said intermediate portion of said cover.

42. A process for manufacturing a package assembly of claim 41 wherein said adhesive is glue.

43. A process for manufacturing the package assembly of claim 41 wherein a first amount of adhesive is dispensed along a distal edge of the intermediate portion of said cover in the form of a line.

44. A process for manufacturing the package assembly of claim 41 scoring at least one spot on the lower portion of said cover for application of an adhesive.

45. A process for manufacturing the package assembly of claim 41 wherein a second amount of adhesive is dispensed to a scored portion of the lower portion of the intermediate portion of said cover.

46. A process for manufacturing the package assembly of claim 41 wherein said blister tray is secured to said cover by activating said first amount of adhesive with heat.
